(19) United States
(12) Patent Application Publication
(10) Pub. No.: US 2009/0139051 A1
(43) Pub. Date: Jun. 4, 2009

(54) HAND TOOLSITLE

(76) Inventor: STUART HOBBS, Norton (GB)

Correspondence Address: LACKENBACH SIEGEL, LLP, LACKENBACH SIEGEL BUILDING, 1 CHASE ROAD, SCARSDALE, NY, 10583, US

(21) Appl. No.: 12/324,489

(22) Filed: Nov. 26, 2008

(30) Foreign Application Priority Data
Dec. 1, 2007 (GB) 0723557.5

(51) Int. Cl. B25G 1/00

(52) U.S. Cl. 16/110.1

(57) ABSTRACT

The present invention relates to an improvement relating to hand tools, particularly handles of hand tools. A hand tool handle includes a body having one or more pads being mounted on a surface, intra surface, inter-surface or a combination of the same on the hand tool handle. Each pad includes one or more enclosed volumes housing a fluid bound by a defined envelope. The fluid may be a liquid, gas, gel, semi-solid gel, colloidal solution, or any combination of the same and may further include a dye or other agent to retain consistency and composition post manufacture. During forming the entrapped fluid is at a super atmospheric pressure or is introduced into a compartment defined by the enclosed volume envelope subsequent to manufacture with a method for sealing an introduction route following introduction.

### CROSS REFERENCE TO RELATED APPLICATIONS

This application relates to and claims priority from GB 0823557.5 filed Dec. 1, 2007, the entire contents of which are incorporated herein by reference. This application additionally relates to and claims priority from U.S. Design Ser. No. 29/319,003 filed Jun. 2, 2008 which in turn claims priority from European Community (OHIM) Design Application No. 000839055 filed Dec. 1, 20007, and its divisional European Community Application No. 000867098 also accorded a filing date of Dec. 1, 2007 (same application as 000839055 but issued under 000867098) at the time of issuance, the entire contents of each of which are incorporated herein fully by reference.

### FIGURE SELECTED FOR PUBLICATION

FIG. 1

### BACKGROUND OF THE INVENTION

1. Field of the Invention

The present invention relates generally to hand tools. More particularly, the present invention relates to improvements to hand tool handles.

2. Description of the Related Art

In recent times consideration has been given to the comfort and tactile aspects of hand tool handles. Such handles can often be in use for long periods of time and factors such as the shape of handles and the materials from which they are produced can lead to significant technical benefits including reduced fatigue.

It is known to provide hand tool handles with cover materials formed from a thin layer of soft, elastomeric material which can improve the shape, tactile and aesthetic aspects of the handles. However, in known hand tool handles the material is solid which presents limitations in the benefits which can be provided.

Accordingly, there is a need for an improved hand tool handle construction.

### SUMMARY OF THE INVENTION

The present invention relates to an improvement relating to hand tools, particularly handles of hand tools. A hand tool handle includes a body having one or more pads which may be removable being mounted on a surface, intra surface, inter-surface or a combination of the same on the hand tool handle. Each pad includes one or more enclosed volumes housing a fluid bound by a defined envelope. The fluid may be a liquid, gas, gel, semi-solid gel, colloidal solution, or any combination of the same and may further include an indicative dye to indicate a density or use characteristic, or other agent to retain consistency and composition post manufacture. During forming the entrapped fluid is at a super atmospheric pressure or is introduced into a compartment defined by the enclosed volume envelope subsequent to manufacture with a method for sealing an introduction route following introduction.

According to the present invention there is provided a hand tool handle comprising a body having one or more pads, each pad comprising one or a plurality of enclosed volumes housing a fluid and defined by an envelope.

The provision of an envelope allows the use of a fluid which in turn allows the use of new materials in conjunction with hand tool handles.

The fluid may comprise any suitable gas or liquid, such as air or water. Alternatively or additionally the fluid may comprise a gel. The gel may be any semi-solid colloidal solution or jelly.

The fluid may include a colored dye. This may be especially desirable when used in conjunction with a transparent envelope that exposes its contents. The color of the fluid may be indicative of its properties, such as an indication of how hard the material is.

One advantage of the use of enclosed volumes for the pad lies in the fact that the fluid may be retained in the envelope under pressure; accordingly the appropriate pressure required for specific circumstances may be chosen.

Techniques for producing integrally molded such pad structures may include those in which the molding takes place under pressure such that the entrapped fluid is at super atmospheric pressure upon forming the envelope, or processes in which the fluid under such pressure is introduced into the compartment defined by the envelope subsequent to manufacture, with a suitable means for sealing the introduction route being provided.

In view of its intended use at the surface of the hand tool handle, the fluid-containment envelopes are preferably made of a material sufficiently resistant to tearing or rupture as to be substantially non-rupturable in use. Then envelopes, at least when filled, may also be at least partly resilient to provided compliance for the pad.

The or at least one of the pads may be surface-mounted on the body. Accordingly, the pad could be provided with suitable attachment means for associating it with a hand tool handle, such as an adhesive pad or the like.

The or at least one of the pads may be held in a recess formed in the body. Accordingly, the hand tool handle body may be provided with one or more recesses into which the pad can be fitted so that at least part of the pad is exposed at the surface of the body in use.

The or at least one of the pads may be held in a cavity formed in the body and through which the pad projects. The body may be formed as a casing for receiving theor each pad. In some embodiments a body is formed from a casing comprising one or more apertures through which pads project whilst retained within the interior thereof.

The or each pad may be formed on a base or substrate layer. This may be particularly advantageous where two or more pads are provided so that a defined relative position of the pads can be achieved on the base, which has benefits for subsequent assembly processes. Furthermore, the base layer itself may serve as a medium for addition of markings or other indicia such as information about the product or marketing information such as trademarks.

The pad may be formed as a shaped element, for example at least partly conformed to the shape of the intended recipient i.e. that part of the user's hand which will grip the handle at that point.

The pads may be formed as a removable element which would allow selective use of pads and/or substitution with pads having different properties such as shape, size, contours or enclosed fluid.

The pads maybe pre-inflated with fluid. Alternatively the pads maybe inflatable. Inflatable pads could allow for their size and/or shape to be adjusted.

The pad/s may extend over the whole or part of the exterior of the handle. In most embodiments it is anticipated that each pad will be a discrete cushioning structure. However, a jacket-like structure fitting around the whole or a substantial part of the handle may also provided.

The hand tool handle may comprise, for example, a paintbrush handle, a paint roller handle or a scraper tool handle.

The above, and other objects, features and advantages of the present invention will become apparent from the following description read in conjunction with the accompanying drawings, in which like reference numerals designate the same elements.

### BRIEF DESCRIPTION OF THE DRAWINGS

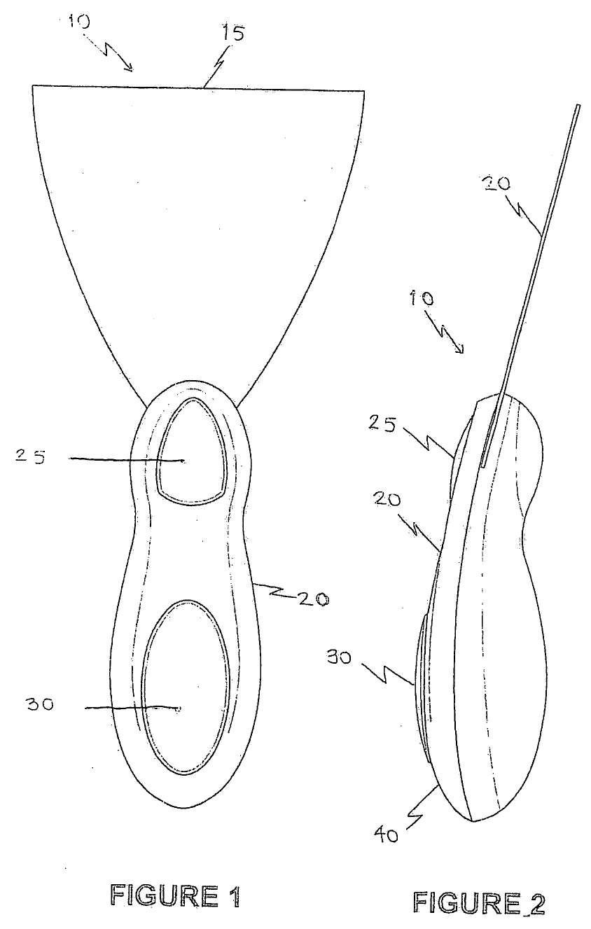

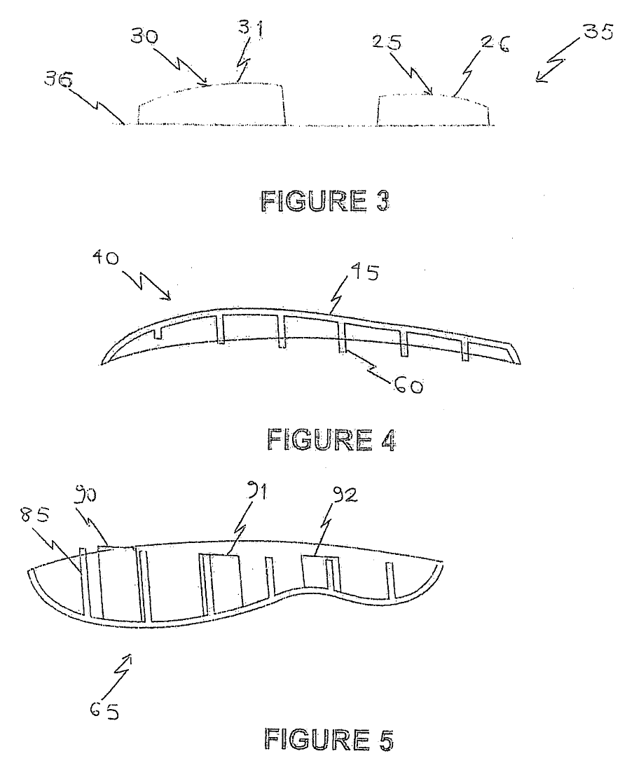

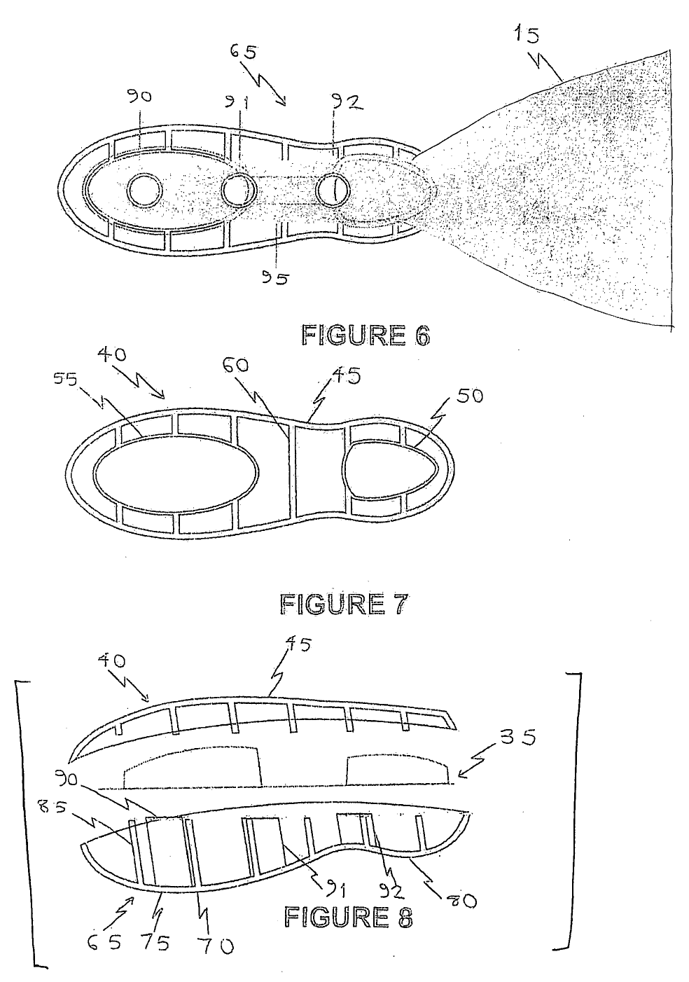

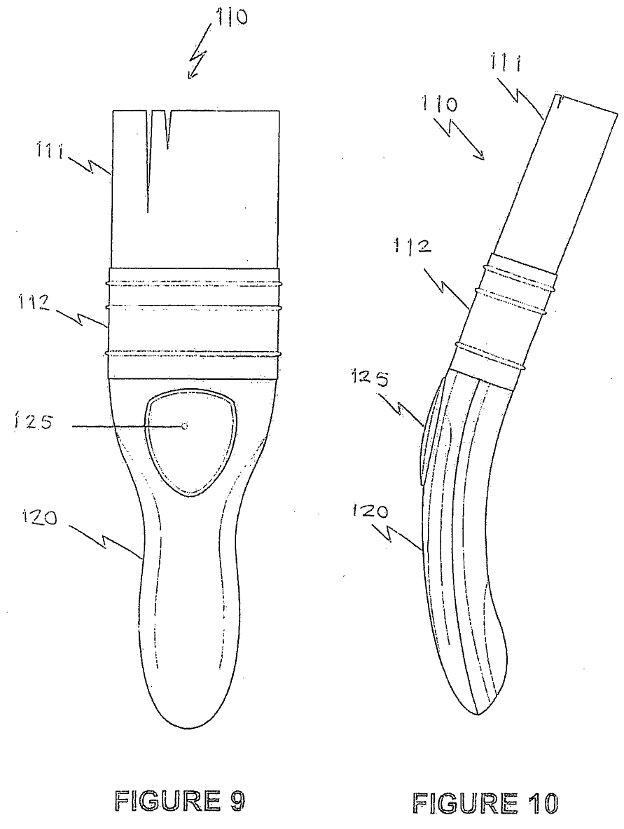

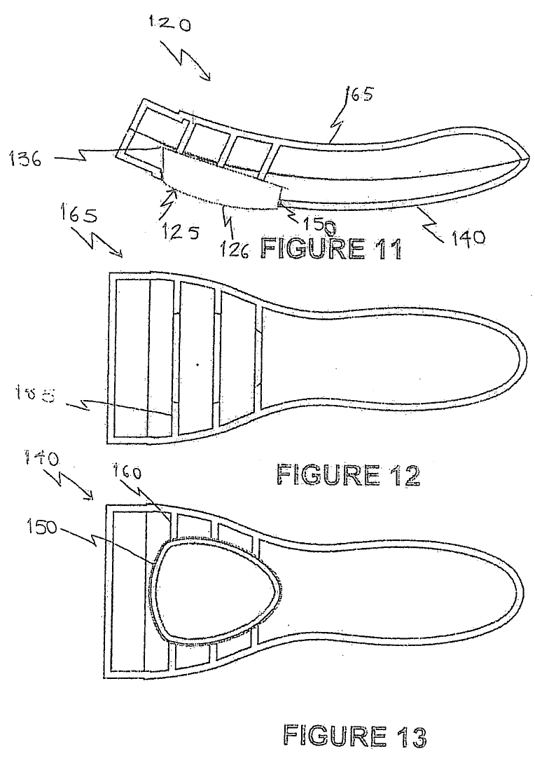

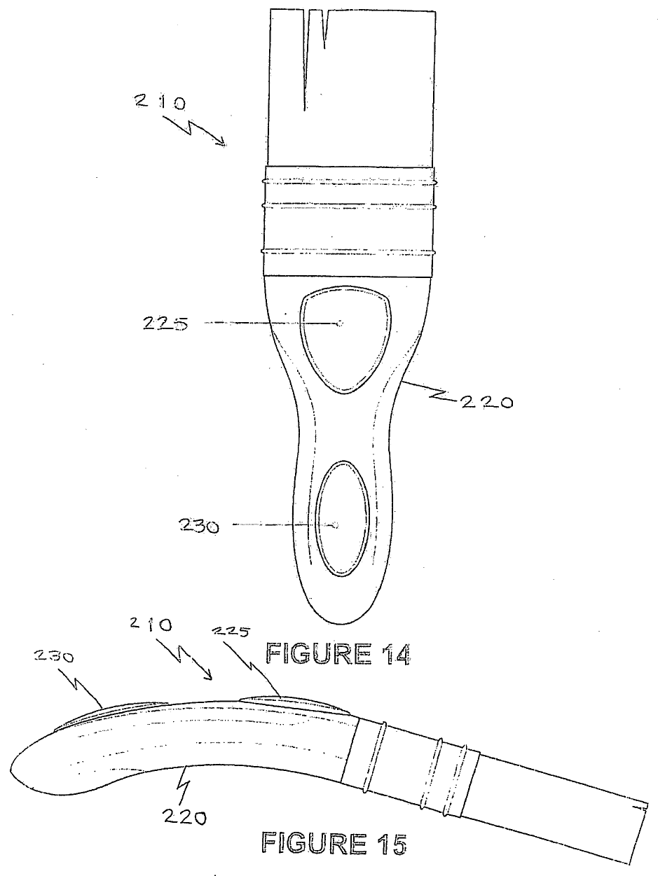

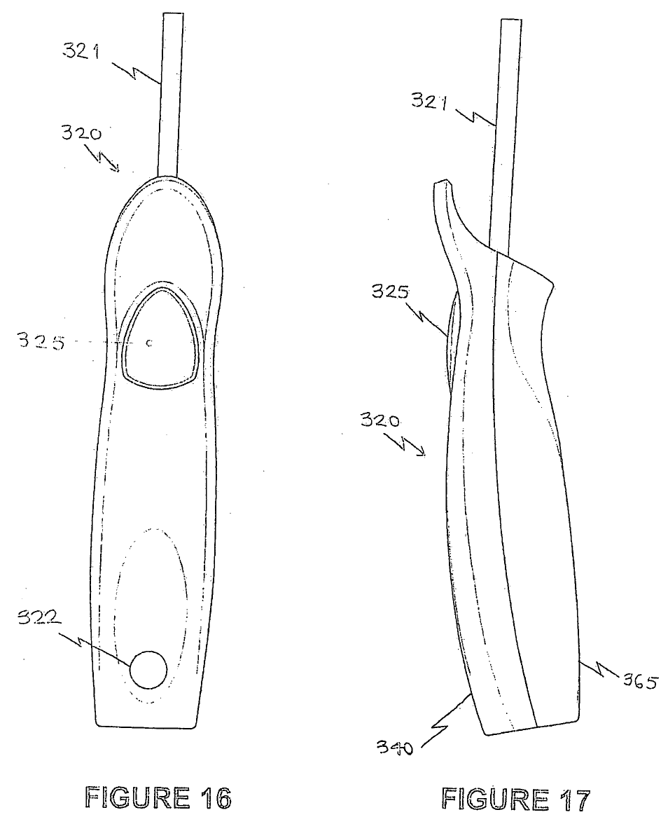

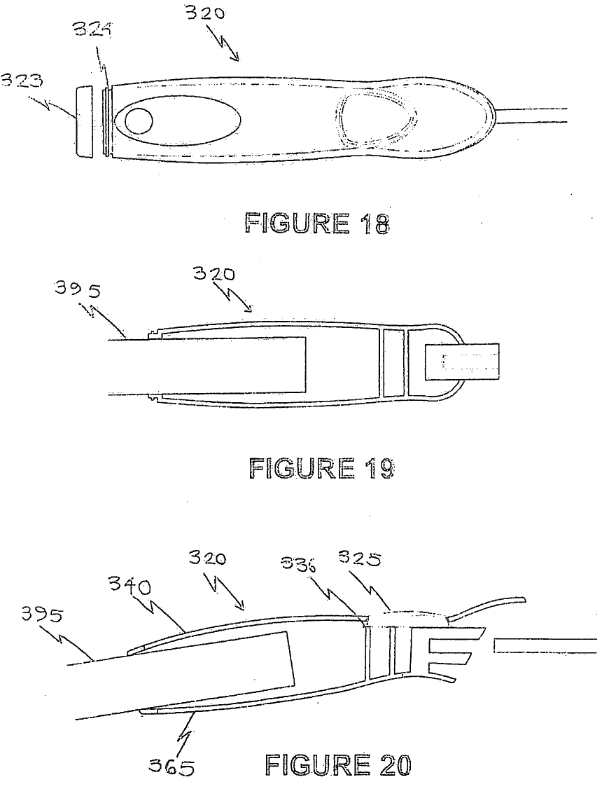

FIG. 1 is a plan view of a scraper tool formed in accordance with a first embodiment of the present invention;

FIG. 2 is a side elevation of the scraper tool of FIG. 1;

FIG. 3 is a representative sectional view of a joined pad arrangement forming part of the scraper tool of FIGS. 1 and 2;

FIG. 4 is a representative section of an upper casing part forming part of the scraper tool of FIGS. 1 and 2;

FIG. 5 is a representative section of a lower casing part forming part of the scraper tool of FIGS. 1 and 2;

FIG. 6 is an underplan view of the lower casing part of FIG. 5 with a shadow illustration of a scraper as shown in FIG. 1;

FIG. 7 is an underplan view of the upper casing part of FIG. 4;

FIG. 8 is an exploded sectional view of the hand tool of FIGS. 1 and 2;

FIG. 9 is a plan view of a paintbrush formed in accordance with a second embodiment of the present invention;

FIG. 10 is a side elevation of the paintbrush of FIG. 9;

FIG. 11 is a representative section of the paintbrush handle shown in FIGS. 9 and 10;

FIG. 12 is an underplan view of a lower casing part forming part of the handle shown in FIGS. 9 and 10;

FIG. 13 is an underplan view of an upper casing part forming part of the handle shown in FIGS. 9 and 10;

FIG. 14 is a plan view of a paintbrush formed according to a third embodiment of the present invention;

FIG. 15 is a side elevation of the paintbrush shown in FIG. 14;

FIG. 16 is a plan view of a paint roller handle formed in accordance with a fourth embodiment of the present invention;

FIG. 17 is a side elevation of the handle shown in FIG. 16;

FIG. 18 is a plan view of the handle shown in FIG. 16 with an end cap removed;

FIG. 19 is a section of the handle shown in FIG. 18 illustrated with an extension pole inserted and;

FIG. 20 is a section of the handle shown in FIG. 17 illustrated with an extension pole inserted.

### DETAILED DESCRIPTION OF THE PREFERRED EMBODIMENTS

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, and below may be used with respect to the drawings. These and similar directional terms should not be construed to limit the scope of the invention in any manner. The words “connect,” “couple,” and similar terms with their inflectional morphemes do not necessarily denote direct and immediate connections, but also include connections through mediate elements or devices.

Referring first to FIGS. 1 and 2 there is shown a scraper tool generally indicated 10. The tool 10 comprises a blade 15 and a handle 20.

The handle 20 is provided with two pads 25, 30. The pad 25 is positioned at the end of the handle proximal the blade 15 and is generally triangular in plan. The pad 30 is positioned at the end of the handle distal to the blade and is generally ellipsoidal in plan. As shown best in FIG. 2, the pads 25, 30 project above the line of the handle 20 to form domed structures.

Referring now to FIGS. 3 to 5 the components of the handle 20 are shown in more detail. Referring first to FIG. 3 the pad arrangement 35 is illustrated. The pads 25, 30 are formed on a base structure 35. The pads themselves are formed as envelopes for containing fluid, which in this embodiment is a gel material. The base 35 and pad envelopes 26, 31 are formed from a plastics material.

Referring now to FIGS. 4 and 7, an upper casing part 40 of the handle 20 is shown. The casing part 40 comprises a curved top plate 45 which includes two apertures 50, 55 sized and shaped to receive the pads 25, 30 as described in more detail below. The casing part 40 also includes a plurality of lateral strengthening ribs 60.

A lower casing part 65 is shown in FIGS. 5 and 6. The casing parts 65 comprises a back plate 70 including a major curve 75 at one end and a minor curve 80 at the other. A plurality of lateral strengthening ribs 85 extend across the interior width of the part 65.

The interior of the part 65 also comprises three upstanding posts 90, 91, 92 which are equally spaced along the length of the part 65. The posts 90, 91, 92 correspond to three circular apertures formed in the tang 95 of the blade 15.

The upper and lower casings 40, 65 are formed from a solid plastic material, such as polypropylene or polyethylene.

As shown best in FIG. 8, the handle 10 is assembled by sandwiching the pad assembly 35 between the upper and lower casing parts 40, 65. The pads 25, 30 project through the apertures 50, 55 as shown best in FIG. 2. The upper and lower casing parts 40, 65 can be secured together by any suitable means such as ultrasonic or heat welding, friction fit or adhesion.

Referring now to FIGS. 9 and 10 there is shown a paintbrush generally indicated 110. The paintbrush comprises a bristle cluster 111, a ferrule 112 and a handle 120.

The handle 120 is curved along its length to give an ergonomic grip.

A generally triangular or shield-shape pad 126 is provided on an upper surface of the handle at the end proximal to the ferrule 112.

Referring now to FIGS. 11 to 13 the construction of the handle 120 is shown in more detail.

The handle 120 comprises an upper casing part 140 and a lower casing part 165.

The construction of the handle 120 is very similar to that of the scraper tool handle 20 shown in FIGS. 1 to 8 in that the gel pad 125 is provided on a base 136 and fits into a cavity formed between the upper and lower casing parts 140, 165, projecting through an aperture 150 in the upper casing part 140.

In this embodiment the envelope 126 defining the pad 125 is filled with air under pressure to provide the cushion-like elements.

Referring now to FIGS. 14 and 15 there is shown a paintbrush generally indicated 210.

The paintbrush 210 is very similar to the paintbrush 110 shown in FIGS. 9 and 10 with regard to its overall shape. However, in this embodiment the handle 220 is formed as a solid, one-piece construction. In this embodiment the handle 220 is provided with two gel pads 225, 230. The pads 225, 230 are surface-mounted on the exterior of the handle body using adhesion.

Referring now to FIGS. 16 to 20 there is shown a paint roller handle generally indicated 310.

The handle 320 comprises a single generally triangular gel pad similar to the pad 25 shown in FIG. 1. The pad 325 is provided towards the end of the handle proximal a socket for receiving the rod 321 of a paint roller support. The opposite end of the handle has a hanging hole 322 passing therethrough.

As shown best in FIG. 20, the handle 320 comprises an upper casing part 340 and a lower casing part 365. The pad 325 is formed within a cavity created between the two parts 340, 365.

As shown in FIG. 18, the end of the handle proximal the hanging hole 322 is provided with an end cap 323 which includes an internal snap bead (not shown) for engaging a corresponding snap bead 324 provided at the end of the handle 320. When in place, the end cap 323 assists in holding the two parts of the casing 340, 365 together. When removed, the cap 323 reveals a socket for receiving an extension pole 395 as shown in FIGS. 19 and 20.

In the claims, means- or step-plus-function clauses are intended to cover the structures described or suggested herein as performing the recited function and not only structural equivalents but also equivalent structures. Thus, for example, although a nail, a screw, and a bolt may not be structural equivalents in that a nail relies on friction between a wooden part and a cylindrical surface, a screw's helical surface positively engages the wooden part, and a bolt's head and nut compress opposite sides of a wooden part, in the environment of fastening wooden parts, a nail, a screw, and a bolt may be readily understood by those skilled in the art as equivalent structures.

Having described at least one of the preferred embodiments of the present invention with reference to the accompanying drawings, it is to be understood that the invention is not limited to those precise embodiments, and that various changes, modifications, and adaptations maybe effected therein by one skilled in the art without departing from the scope or spirit of the invention as defined in the appended claims.

1.-11. (canceled)

12. A hand tool handle construction, comprising:
a body having at least one pad enabling a gripping by an external user during a use; and
each said at least one pad further comprising:
at least one enclosed volume housing a fluid and defined by an envelope.

13. A hand tool handle construction, according to claim 12, wherein:
at least one of said pads is surface mounted on said body.

14. A hand tool handle construction, according to claim 12, wherein:
at least one of said pads is held in a recess formed in said body.

15. A hand tool handle construction, according to claim 12, wherein:
at least one of said pads is held in a cavity formed in said body and through which said at least one pad projects outwardly away from said body.

16. A hand tool handle construction, according to claim 12, wherein:
said body is formed as a casing for receiving said at least one pad.

17. A hand tool handle construction, according to claim 12, further comprising:
at least one base layer member; and
said at least one base member formed under said at least one pad and secured thereto.

18. A hand tool handle construction, according to claim 12, wherein:
said fluid is at least one of a gel, a liquid, a gas, and a combination of a gel a liquid or a gas

19. A hand tool handle construction, according to claim 12, further comprising:
means for removably securing said at least one pad to said body.

20. A hand tool handle construction, according to claim 12, wherein:
said body contains at least two said pads;
each said bad being held in a recess formed in said body and projecting outwardly away from said body enabling said gripping during said use; and
said fluid in each said pad is a gel.

21. A hand tool handle construction, according to claim 12, wherein:
said body contains at least two said pads;
at least one base layer member fixably secured to each said pad and also removably secured to said body by means for removably securing each said based layer to said body;
said fluid in each said pad is a gel; and
said at least one base layer member between said pad and said body and containing a visual indicia marking relative to a use of said pad.
